(19) United States
(12) Patent Application Publication
(10) Pub. No.: US 2013/0006698 A1
(43) Pub. Date: Jan. 3, 2013

(54) METHOD AND APPARATUS FOR MANAGING PROCESS FLOW

(75) Inventors: Suman Roy, Bangalore (IN); Kiran Prakash Sawant, Mumbai (IN)

(73) Assignee: INFOSYS LIMITED, Bangalore (IN)

(21) Appl. No.: 13/173,568

(22) Filed: Jun. 30, 2011

(51) Int. Cl. G06Q 10/00

(52) U.S. Cl. 705/7.27

(57) ABSTRACT

An apparatus and method for producing a workflow specification of a business process. The method includes receiving a process flow model of the business process at a computing device, receiving documents corresponding to the business process at a computing device, generating a set of logical formulae representing the control of the process flow model using a computing device, and applying a set of rules representing execution dependencies of activities in the business process to generate a workflow specification of the business process using a computing device.

### BACKGROUND

It is well known to model repeatable business processes as business process flows consisting of a collection of cooperating, coordinated activities which execute a process. Agents, in the forms of a human, a device or a program, are the entities that can perform an activity in a process flow. Modeling, executing and monitoring the activities in a workflow are performed by a computer workflow management system. A number of commercial products are available in the market for modeling and executing workflows.

Researchers have proposed many formal models for analyzing workflows. For example, temporal reasoning, logic based modeling and the use of action description languages for creating workflow specifications are known. Also, frameworks based on graphs, event-condition-action rules, and various logics are widely used for specifying workflows. Visualization of a control flow is possible using graph-based approaches, where nodes are associated with activities and edges with control or data flow between activities. For example, Petri net is a well-known formalism that is applied to specify workflows. Event-condition-action rules have also been used in the specification of workflows.

However, control flow graphs are more expressive than these formalisms. Logic-based formalisms use the power of declarative semantics of logic to specify the properties of workflows and the operational semantics of logical systems to model the execution of workflows. In N. K. Cicekli, et al., Formalizing the Specification and Execution of Workflows Using the Event Calculus, Journal of Information Sciences, 176 (2006) 2227-2267, the authors propose a logic-based framework for the specification and execution of workflows using a logic programming style of language called “event calculus.”

UML (Unified Modeling Language) activity diagrams represent business processes occurring in a system. For example, Business Process Modeling Notation (BPMN) is a graphical representation for specifying business processes in a business process model. A Business Process Diagram (BPD) is a type of flowchart incorporating constructs, such as AND-split, AND-join, XOR-split, XOR-join, and other logical elements which are commonly found in business process modeling. A BPD is constructed of graphical elements, like objects and sequence flows. An object in a BPD can be an event, an activity (also called actions) (a simple activity is a task), a gateway (decision box), or even a document. A sequence flow connects two objects in a BPD, which is also known as control flow relation. The four basic categories of elements in a BPD are (1) Flow Objects, including Events, Activities, Gateways; (2) Connecting Objects, including Sequence Flow, Message Flow, Association; (3) Swim Lanes, including Pool, Lane; and (4) Artifacts (Artefacts), including Data Object, Group Annotation.

In a BPD, there is a start event denoting the beginning of a process, an end event denoting the end of a process, and at least one intermediate event occurring during the process. A message event is used to send (except for the start event) or receive (except for the end event) a message. These objects, and control flow relations together constitute the BPD. A sequence is made of a node that has an incoming and an outgoing arc. A choice/merge gateway or connector is a routine construct to control the separation/merge of control flows. It is represented by diamond. A fork (AND-split) node separates two concurrent paths and allows independent execution between concurrent paths within a BPD. It is modeled by connecting two or more outgoing control flow relations to a task. For synchronizing concurrent paths, a synchronizer (AND-join) is used so that it can link all the incoming edges to it. A synchronizer delays its completion until all incoming control flow relations leading into the task complete their execution. From a choice (XOR-split) node, two or more outgoing control flow relations diverge resulting in mutually exclusive alternative paths. This forces one to select only one alternative outgoing control flow relation at run-time. A merge (XOR-join) node is the counterpart of the choice node and connects incoming mutually exclusive alternative paths into one path.

Two processes can be located respectively within separate pools (labeled with process names), called swim-lanes or roles, which represent two participants (e.g., business entities or business roles), these are also called activity diagrams with roles. Examples of such process models having multiple participants are processing of purchase orders over the internet, processing of insurance claims, tour planning and requisition in a company, and the like.

Ontology Web Language (OWL) consists of a set of XML elements and attributes, with standardized meaning, that are used to define terms and their relationships. It is possible to declare classes and organize them hierarchically in a subsumption relationship within an OWL framework. OWL allows combining classes using intersection, union or complementation, or as enumerations of specified objects. The domains of OWL properties are classes, and ranges can be either OWL classes (if they are object properties), or externally defined data-types such as string, or integer (if these are data-type properties). Further, there is provision in OWL for making a property transitive, symmetric, functional, or inverse of another property.

OWL can also be used to express facts, such as which objects (also called “individuals”) belong to which classes and what the property values are of specified individuals. One can make equivalent statements on classes and on properties, disjointness statements on classes, and assert equality and inequality between individuals. While the syntax of OWL corresponds to that of RDF, the semantics of OWL are extensions of the semantics of Description Logic. Thus, OWL shares many common features with Description Logic.

However, OWL still has limited expressivity. For example, OWL cannot be used to express much detail about the properties. In order to overcome these limitations, OWL has been extended with Horn Clause rules. In order to overcome these limitations Horrocs et. al. have extended OWL with Horn Clause rules, which is known as, Semantic Web Rules Language (SWRL) in I. Horrocks, P. F. Patel-Schneider, S. Bechhofer, and D. Tsarkov. OWL rules: A proposal and prototype implementation. Web Semantics: Science, Services and Agents on the World Wide Web, 3(1):23-40, July 2005. OWL is extended to SWRL in a syntactically and semantically coherent manner; the basic syntax of SWRL rules is an extension of the OWL syntax, and SWRL rules are interpreted by extending the model theoretic semantics for OWL.

### SUMMARY

The embodiments disclosed herein utilize a rule-oriented framework for specification and execution of process flows. A SWRL (Semantic Web Rule Language) based approach is used for the specification of control flow graphs, execution dependencies among activities, and scheduling of activities within a process flow. As an example, rules for activity scheduling, and agent-assignment can be applied to a UBL (Uniform Business Language) process for illustrating the approach.

Specification of a process model involves capturing relevant aspects of its constituent activities, the relationships among activities and their execution requirements. In a process flow, activities are related to each other through control flow relation/transition relation. It is possible to identify process flows with a few known transition patterns such as, sequential, parallel, conditional, iteration, and the like. Further, execution semantics of activities of process flows can be expressed. The embodiments of SWRL provide a suitable logical framework to capture both the specification and execution semantics of activities in business processes. A decidable fragment of first-order logic is used.

### BRIEF DESCRIPTION OF THE DRAWING

FIG. 1 is a flow diagram of a sequential activity.

FIG. 2(a) is a flow diagram of an AND-split as a concurrent activity.

FIG. 2(b) is a flow diagram of an AND-join as a concurrent activity.

FIG. 3(a) is a flow diagram of an XOR-split as a conditional activity in an XOR gateway.

FIG. 3(b) is a flow diagram of an XOR-join as a conditional activity in an XOR gateway.

FIG. 4(a) is a flow diagram of an iterative activity.

FIG. 5 is an activity diagram for the example of the Freight Billing process.

FIG. 6 is a table of the classes and subclasses for the example of the Freight Billing process.

FIG. 7 is a table of the object properties and respective inverses for the example of the Freight Billing process.

FIG. 8 is a high level flow chart of a method of the embodiment for creating a process specification.

FIG. 9 is a block diagram of a computer architecture of the embodiment.

While systems and methods are described herein by way of example and embodiments, those skilled in the art recognize that the invention is not limited to the embodiments or drawings expressly described herein. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

OWL can be extended with SWRL in a syntactically and semantically coherent manner. The basic syntax of SWRL rules is an extension of the OWL syntax, and SWRL rules are interpreted by extending the model theoretic semantics for OWL. However an arbitrary extension of OWL with rules could easily lead to undecidability of interesting problems. For this reason, the disclosed embodiments focus on a decidable fragment of such an extension using the so-called “DL-safe rules”, which force each variable in a rule to occur in a non-DL atom in the rule body. “DL” stands for Description Logic.

The disclosed process flow management system is capable of both specifying and executing activities. The applicants have dealt with axioms for specifying the process flow, and the description of scheduling pre-conditions among the activities using OWL. The disclosed embodiments use an agent assignment module, such as part of a process flow manager that coordinates the execution of the activities according to a specification of process flow. When an activity is considered, the manager must assign an agent that will execute the activity. Each agent can perform one or more activities, and each activity can be executed by one or more agents. However, generally, an agent can only perform only one activity at a time. Once an agent begins an activity, its status is changed to busy and no further activities are assigned thereto until the activity has been completed. When an activity is selected for execution, an agent that is qualified to perform this activity is selected, and eventually that agent is assigned the activity if it is idle.

The classes Agent, Activities and Events are introduced to denote the set of agents, activities and events respectively. There are some events which lead to the beginning and ending of the process, which are denoted as StEvents, EndEvents ⊂ Events, respectively. For each activity Act, individuals Start_Act and End_Act are used for instantiating the classes StEvents and EndEvents respectively. A predefined predicate happens ⊂ Events is used to record occurrences of new events. A new class called Conditions is used and a class Holds_at is a subclass of Conditions. For example, “Holds_at(c)” means that the event holds at condition c. For example, consider the roles such as, assign; begin, over ⊂ Agent x Activities. The statement “assign(Ag, Act)” means the activity Act is assigned to agent Ag. The statement “begin(Act, Ag)” means the agent Ag has started executing the activity Act. The statement “over(Act, Ag)” means the agent Ag has completed executing the activity Act.

100271 Rules can be used to assign an activity to an agent. For example, there can be rules for beginning an activity, recording the completion of an activity and the rules for releasing an agent. An agent that is qualified to perform an activity can be selected to perform that activity, provided that the agent is currently idle, i.e. not performing another activity. A Datatype property status, which can have either of “busy” or “idle” as its value, is used to check the condition of a particular agent. The statement qualified(Ag, a) denotes that agent Ag is qualified to execute activity a.

In the disclosed embodiment, the following rules are used to assign a particular agent to an activity. We adopt a simple model in which it is assumed that an agent is assigned an act only once, and one agent is qualified to perform only one activity. All agents are idle at the beginning..assign(Ag, Act)←qualified(Ag, Act).

An activity starts to be executed only when it is assigned to an agent. This is captured by the following rule.
begin(Act, Ag)←assign(Ag, Act), happens(Start_Act)

When an activity is completed, the ending event is recorded and, subsequently, the agent is released. This is expressed by the following rule.
over(Act, Ag)←begin(Act, Ag), happens(End_Act)

After the completion of an activity, the corresponding agent is released using the following rule.
release(Act, Ag)←over(Act, Ag)

It can be assumed that all events occur instantaneously, i.e. there is no time lapse from the beginning to the end of an event. The agent performing the activity should inform the process flow manager about the end of the activity. The following rule is used to record the end of an activity.
happens(End_Act)←happens(Start_Act), qualified(Ag, Act)

A logic programming-like formalism is used to record specifications for UBL processes. For each activity a that has started start_a, and end_a is used to denote the beginning and completion of activity a. Keep in mind that, follows(a₁, a₂) is a transitive property which expresses that activity a₁ follows a₂. For denoting that activity a1 makes transition to activity a2 through conditional gateways or vacuously, we use the role transits to(a₁, a₂). Axioms can be used to state that a property holds under certain conditions. Again, since all events are assumed to be instantaneous, there is no time spent from the beginning to the end of an event.
holds_at(c)←happens(e), initiates(e,c), non-interrupted(c),
interrupted(c)←happens(e), terminates(e,c),
non-interrupted(d)←allKnown(c,L), interrupted(c), not-in-list(d,L).

As negation cannot be expresses in SWRL, the embodiment introduces a new swrl builtin, called allKnown. This works similarly to the set of predicate in Prolog—it returns a list of all the “known” values of some property, for some individual. Once we have lists of property values, swrl's list built-ins can be used to check whether one list is contained in another and so forth.

Predicates are defined below.

holds at(c) denotes that the condition c holds

happens(e) denotes that the event has occurred

initiates(e, c) denotes that the event e initiates a period of time (implicit) during which the condition c holds

terminates(e, p) denotes that event e puts an end to a period during which c was true

The property interrupted is a Boolean concept which takes a condition as its domain. A condition c is said to be interrupted if the concept interrupted is evaluated to true.

The disclosed embodiments can specify sequential activities in OWL. For example, suppose the activity aⱼ can start unconditionally, when activity aᵢ finishes. This is captured as the following rule.
transitsto(aᵢ, aⱼ)←follows(aᵢ, aⱼ), happens(end_aᵢ)

An inverse property can also be defined for example, before(aⱼ,aᵢ) corresponding to follows(.,.) can be expressed by the following rule.
reverses to(aⱼ,aᵢ)←before(aⱼ,aᵢ), happens(start_aⱼ)

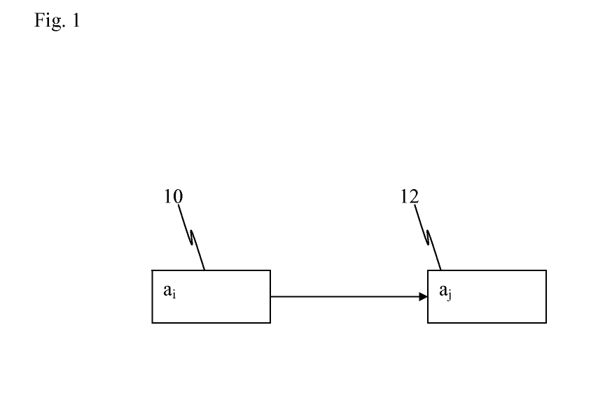

FIG. 1, illustrates the sequential activity described above. In FIG. 1, it can be seen that activity aⱼ begins at 12 only after activity aᵢ has completed at 10.

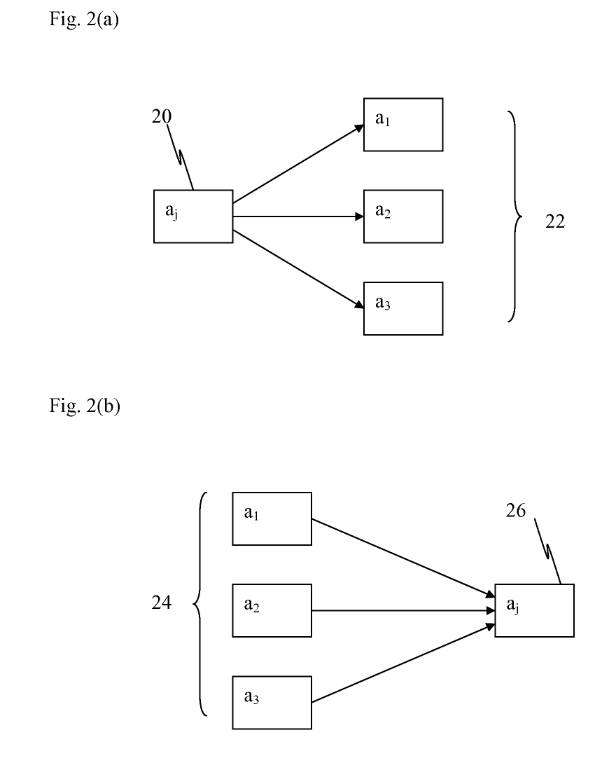

Of course, in a process flow, some activities might be executed concurrently, i.e. almost at the same time. For example, activities after an AND-split are scheduled to be executed concurrently. FIG. 2(a) illustrates an AND-split. Activities a₁, a₂, and a₃ can start only when the activity aⱼ, j ∈ {1, 2, 3} finishes at 20. Also, a₁, a₂, and a₃ occur concurrently at 22. This can be captured by the following rule.
transitsto(aᵢ,aⱼ)←and_split(aⱼ,L),happens(end(aⱼ)), member(x,L)
   where L={a1 . . . aₙ} is a list of actions

Note that the variable x assumes a value from the set {a₁ . . . aₙ}. The predicate and_split(aⱼ,L) denotes that activity aⱼ is split into a list L of activities, and predicate member(x,L) denotes that variable x for an activity is a member of list L.

FIG. 2b illustrates an AND join situation. In this case, the activity aⱼ can start at 26 only when all the preceding activities a₁, a₂, a₃ have finished at 24. These activities might not be completed concurrently. However, in the embodiment, we assume there is no time elapsed for completion of activities. The following rule can be used to represent the execution of an AND-join.
transitsto(x,aⱼ)←and_join(L, aⱼ), happens(end_a₁)), . . . , happens(end_aₙ)), member(x,L)

Note that the rules above accommodate a finite number of concurrent tasks. The examples in the drawings have been limited to 3 concurrent tasks for the sake of simplicity. The predicate and join(L, aⱼ) indicates that the activities in the list L are merged into the activity aⱼ. Further, member(a₁,L) . . . , member(aₙ,L) etc. . . . denote that activity aᵢ is a member of the list L, 1≦i≦n.

In a process some of the activities are enabled depending on certain conditions. If the condition does not occur, they are not executed. An important point is that, in the embodiments, only one of the conditions should hold at the time of decision, so that only one path is taken.

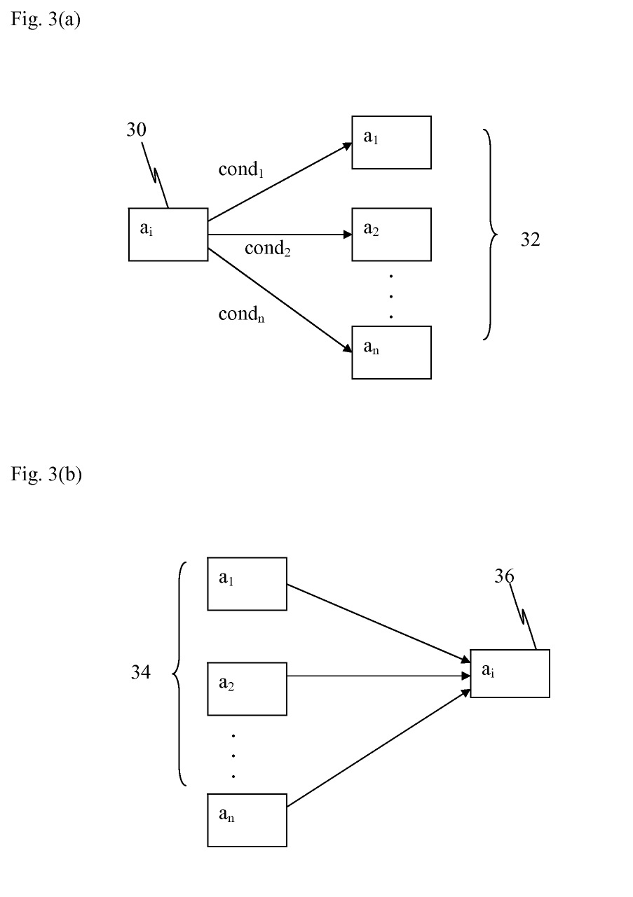

FIG. 3(a) illustrates these conditional circumstances in an XOR-split situation. In this case, when activity aᵢ finishes at 30, one of the activities a₁, . . . , aₙ (i ∈ {1, . . . , n}), at 32, can begin depending on whether the condition associated with that particular activity is satisfied. For example, the condition may be some kind of condition check, e.g., “swrlb:condition”, which may be one of SWRL buitin predicates.

Conditions on transitions are mutually exclusive. For example, on the completion of the activity aᵢ, one of the activities a₁, . . . , aₙ can be executed depending on the other condition evaluated. This can be specified as follows.
transitsto(aᵢ, a₂)→xor_split(aᵢ, L), happens(end_aᵢ), dtp-pair(a₂, cond₂), swrlb:cond₂.

Here predicate xor_split(aⱼ, L) denotes that the activity aⱼ gets split into a set of activities a₁, . . . , aₙ, and dataype property dtp-pair(aᵢ, condᵢ) means that activity aᵢ is associated with the condition condᵢ (“string”) in this gateway.

FIG. 3(b) illustrates similar (to above) conditional circumstances in an XOR-join situation. In this case, when one of incoming activities to the join is completed at 34, the outgoing activity at 36 can start. The incoming activities need not have to be synchronized. The completion of one of the incoming activities is sufficient to trigger the beginning of the merged activity. However, it is important to ensure that the follow-up activity is started only once. The following rule captures this situation.
transitsto(a₁, aᵢ)←xor_join(L, aᵢ), happens(end_a₁), not-happens(end_a₂), not-happens(end_a₃), . . . , not-happens(end_aₙ)

In the above, xor_join(L , aⱼ) indicates that the list of activities get merged into the activity aᵢ. The predicate not happens(end_a) indicates that the activity a has not been completed. Since negation as failure is not supported in SWRL, we need to come out with a strategy to express this kind of negation. Towards that, we use “allKnown(.,.)” predicate again. The following set of rules is added.
occurred(e)←happens(e)
not-happens(e)←allKnown(f,L), occurred(f), not-in-List(e,L)

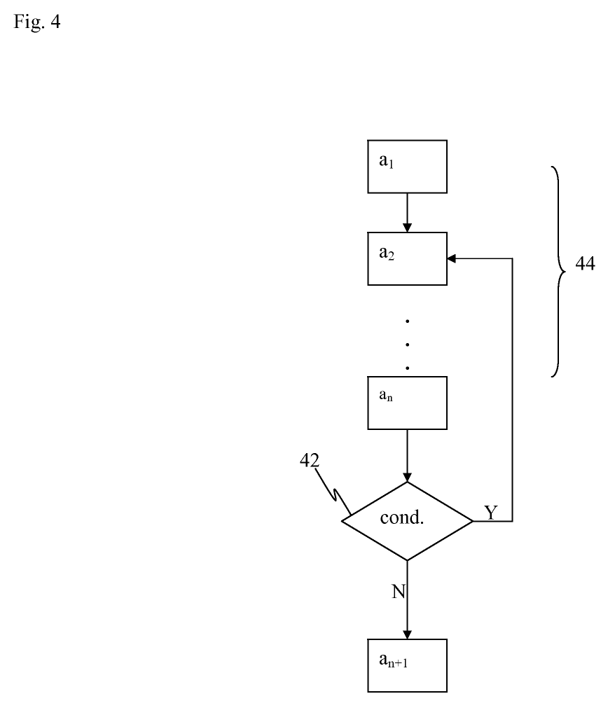

At times, it is required to repeat a set of activities occurring in a loop. FIG. 4 illustrates this situation in that a loop may be executed a certain number of times depending on the exit condition. This iteration of activities may be captured as follows, assuming the activities between a₁ and aₙ can be arranged as any of the transition types.
transitsto(a₁, a₂)←follows(a₁, a₂), happens(end_a₁)
transitsto(aₙ, a₂)←happens(end_aₙ), swrlb:stringEqualIgnoreCase(Condvalue,“Y”)
transitsto(aₙ, aₙ₊₁)←happens(end_aₙ), swrlb:stringEqualIgnoreCase(Condvalue,“N”)

Here, we model the loop condition using builtin swrlb:stringEqualIgnoreCase which is assigned appropriate value at appropriate transitions. Also, the transitions between a₁ and aₙ, shown at items 44, are clearly modeled as sequential activities.

It is assumed here that when activity aᵢ finishes, activity aᵢ starts immediately,
happens(start_aᵢ)←transitsto(aᵢ, aᵢ),
   which forces the rule:
happens(end_aᵢ)←happens(start_aᵢ).
   Note that both transitsto(.,.) and reverses to(.,.) maintain transitivity.

Now to demonstrate an example of a process flow specification, we use SWRL is used to specify a simple process. The embodiment uses processes described using Universal Business Language (UBL), which is an OASIS standard to develop common business document schema.

A UBL process diagram typically consists of process flows and documents as objects in the flow. It is meaningful to specify UBL processes using OWL, as several application domains are making use of ontologies to add the knowledge dimension to their data and applications. To specify UBL processes using OWL, all the agents involved are added to the ontology as classes. The agents are linked using object-properties based on the subprocesses through which they interact. The domain and range for these properties are the classes for the agents and objects that are involved in that subprocess. One can also define the inverse properties for the corresponding object-properties, wherever they would be useful for querying purposes.

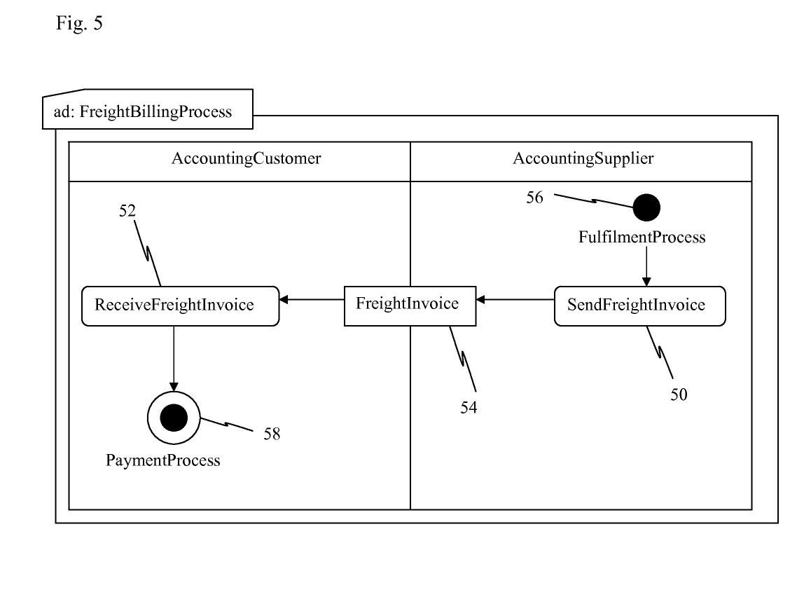

As an example, let us consider a simple process—Freight Billing process; given in FIG. 5, which is bereft of any gateways. The specification is designed separately for process flow, and for process management. In this process diagram, while SendFreightlnvoice, at item 50, and ReceiveFreightlnvoice, at item 52, are Activities, FreightInvoice, at item 54, is an Object. FulfilmentProcess, is an Initial Node shown by a filled circle at item 56, and PaymentProcess, a Final Node shown by a Bull's eye at item 58. Correspondingly, individual activities, Initial_activity, Final_activity, doFulfilmentProcess, doPaymentProcess etc are added. Class Events denoting events is introduced, with subclasses of StEvents and EndEvents. For each activity Act, individual events start_Act and End_Act are generated for classes StEvents, and EndEvents respectively. They denote the beginning and ending respectively of the corresponding activities.

Only three sequential transitions are considered here, Initial_activity→SendFreightInvoice, SendFreightInvoice→ReceiveFreightInvoice, ReceiveFreightInvoice→Final_activity. AccountingCustomer and AccountingSupplier represent two Partitions (swim lanes), which dictates the assignment of agents to events. Three Agents/Actors—System, AccountingCustomer, and AccountingSupplier are considered.

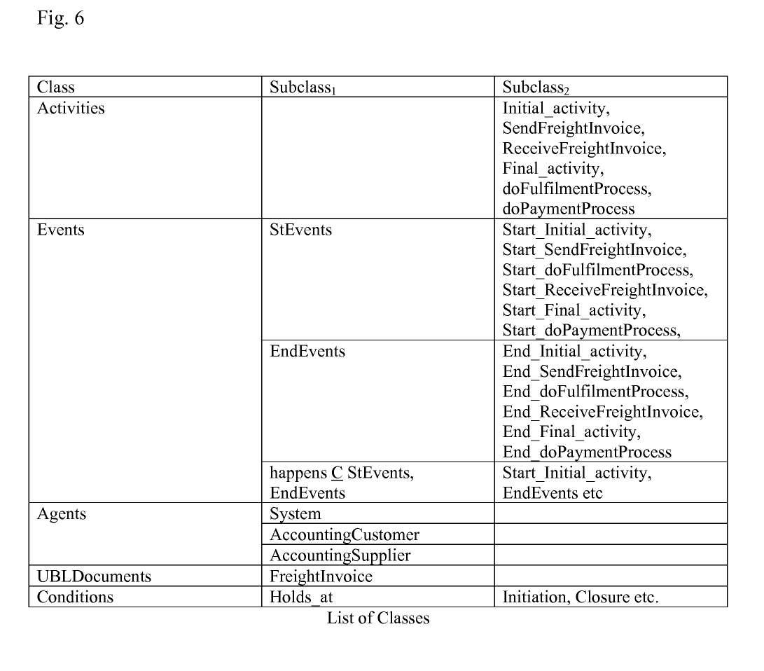

An equivalent OWL Ontology for the Freight Billing process could be constructed as follows. Agents and UBLDocuments are designed as OWL Classes of which the agents involved and the UBL documents involved (given by Objects) become sub-classes, respectively. System, AccountingCustomer and AccountingSupplier, thus become sub-classes of Class Agents, and FreightInvoice becomes a sub-class of Class UBLDocuments. Initial_activity, SendFreightlnvoice, ReceiveFreightlnvoice, Final_activity, doFulfilmentProcess and doPaymentProcess become individual members of Class Activities. A detail of the classes and its individuals/names is illustrated in FIG. 6. Accordingly, the agents and documents have been transformed into an OWL ontology.

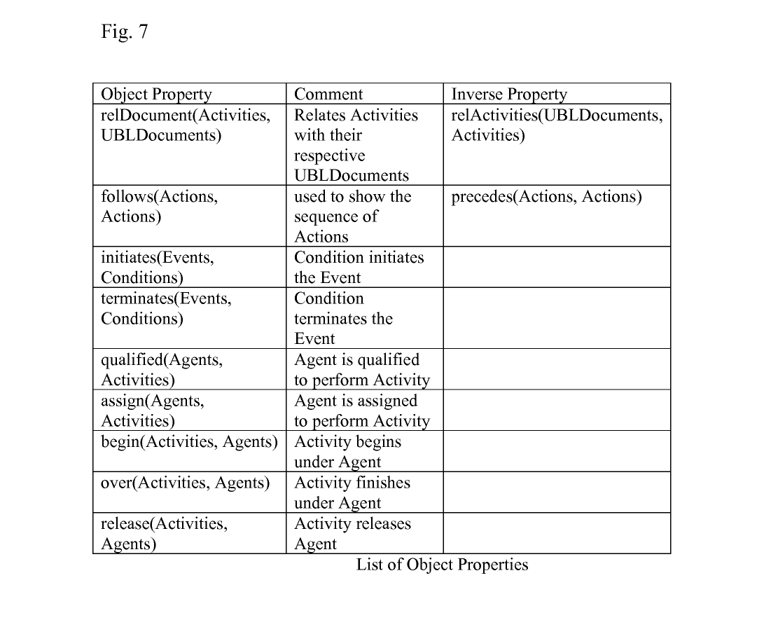

There are some ObjectProperties that are used to generate ontologies. Such properties are discussed in greater detail below with respect to rules. We shall use relDocuments ⊂ Activities×UBLDocuments to relate activities with their respective UBLDocuments. Similarly follows ⊂ Activities×Activities show the sequence of actions. Accordingly, we can instantiate these roles with respect to this FrieghtBilling Process corresponding to three transitions given above. The list of Object Properties along with their inverses is illustrated in FIG. 7.

Different stages of the process can now be captured using rules. A class happens is introduced as a subclass of Events, in which it is assumed that, happens ⊂ StEvents, EndEvents. Consequently, happens(Start_Act) means that activity Act has started, happens(End_Act) says that activity Act has ended.

Similarly, a class called Conditions, and holds_at(.) as a subclass of Conditions are introduced. This class can be instantiated with names Initiation, Conclusion etc, where Initiation is a condition for the FrieghtBilling Process to begin, and where Closure is a condition for the FrieghtBilling Process to end. The role initiates whose domain is Events, and range is the class Conditions. Similarly, there is a role terminates.

For a pre-condition, two facts are needed:
initiates(End_doFulfilmentProcess,Initiation), appens(End_doFulfilmentProcess)
   and the rule:
happens(Start_Initial_activity)←holds_at(Initiation).

Similarly, the post-condition requires the facts:
terminates(End_Final_activity,Conclusion)
   and the rule:
happens(Start_doPaymentProcess)←holds_at(Conclusion).

Also note that for any activity Act the following rule is in place:
happens(End_Act)←happens(Start_Act)

The following sequential activities are considered and the happens rules corresponding to sequential transitions are written.
happens(Start_SendFrieghtInvoice)←
follows(Initial_activity,SendFrieghtInvoice),
happens (End_Initial_activity);
happens(Start_ReceiveFrieghtInvoice)
follows(SendFrieghtInvoice,ReceiveFrieghtInvoice),
happens(End_SendFrieghtInvoice);
happensStart_Final_activity)←follows(receiveFrieghtInvoice,Final_activity), happens(End_ReceiveFrieghtInvoice)

Let us now discuss the assignment of agents as part of process-flow management. Initially, all the individuals of Class Agents are assumed to be idle in the beginning. Also the following facts are used to denote that a particular agent is qualified to perform a particular activity.
qualified(System1,Initial_Activity);
qualified(Supplier1,SendFrieghtInvoice);
qualified(Customer1,ReceiveFrieghtInvoice);
qualified(System1,Final_Activity).

The initial condition below is needed to guarantee
assign(System1,Initial_Activity)←qualified(System1,Initial_Activity)

Now the following triggering rules are considered:
begin(Initial_Activity, System1)←assign(System1,Initial_Activity);
happens(Start_Initial_Activity)
over(initial_Activity,System1)←begin(Initial_Activity,System1);
happens(End_Initial_Activity)
release(Initial_Activity,System1)→over(initial_Activity,System1)
happens(End_Initial_Activity)←happens(Start_Initial_Activity);
qualified(System1, Initial_Activity)

Employing one of sequential rules, one can infer
happens(Start_SendFrieghtInvoice).

An initial condition is likely needed as before to generate the fact
assign(supplier1,SendFrieghtInvoice)

and then move ahead. One can finally arrive at
happens(End_Final_Activity).

Although both OWL-DL and function-free Horn rules are decidable with interesting expressive power, a combination of these two might easily lead to undecidability of interesting reasoning problems. By restricting rules to be DL-safe, decidability is achieved. This requires each variable appearing in a rule to occur in a non-DL atom. This DL safety is similar to the safety in datalog. In a safe rule, each variable occurs in an atomic concept appearing in the ABox. If Person, livesAt, and worksAt are concepts and roles from KB, then the following rule is not DL-safe.
Homeworker(x)←Person(x),livesAt(x,y),worksAt(x,y)

The rule is not DL-safe, because both variables occur in DL-atoms, and do not occur in a concept outside of TBox. This rule is made DL-safe by adding special non-DL literals σ(x) and σ(y) to the rule body, and adding a fact σ(a) for each individual a. Secondly, DL-safety only permits atomic concepts to occur in a rule. The specification of process flows will be DL-safe as in the example we do not use any variable. Also even if variable is used in a few rules, they can be turned to DL-safe ones employing the trick above. Moreover, the second one is not really a restriction in this case, as no non-atomic concept in a rule is used. If we do not consider loops, our ruleset will be decidable by design. The XMI representation of this UBL process diagram is considered and a Perl script is then written to generate OWL ontologies along with rules. An application of this kind of ontology can be seen in requirements authoring. The aim of such a work should be that to build a system which can detect incompleteness and inconsistency in requirements. Ontology, created from the artifacts, can be used to constrain the authoring of requirements so that the possibility of requirements deviations and inconsistencies can be minimized.

As can be seen above, different stages of the process can be captured with rules. As an example, a class happens is introduced as a subclass of Events. Consequently, happens(event_a) means that activity a has occurred. Similarly, we introduce a class called Conditions, and holds_at as a subclass of it. This class can be instantiated with names Initiation, Closure etc, where Initiation is a condition for the FrieghtBilling Process to begin, and Closure is a condition for the FrieghtBilling Process to end.

A significant advantage of the specification disclosed herein is the ability for Querying. To query the OWL ontology thus developed, we make use of SQWRL (Semantic Query-Enhanced Web Rule Language), a SWRL-based query language. SQWRL provides SQL-like operations that can be used to format knowledge retrieved from an OWL ontology. SQWRL closely follows SWRL's semantics and uses the standard SWRL presentation syntax supported by the SWRLTab. SQWRL is defined using a library of SWRL built-ins, and it effectively turns SWRL into a query language.

As an example, a catalog of queries can be provided for the ontology created from UBL documents and processes. Potential queries are listed below:
Find all instances of documents and their corresponding IDs.
Count the number of documents with the same issue dates.
Sort the documents based on various parameters.
Find the next process after a designated process.

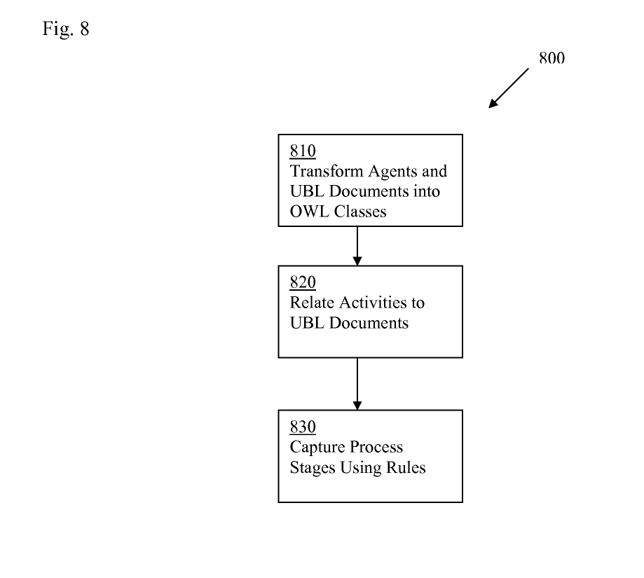

FIG. 8 illustrates a high level of a method 800 for creating a process specification. After receiving the UBL process diagrams and documents, the agents and UBL documents are transformed into OWL classes, as described above, in step 810. In step 820, the activities of the process are related to the UBL documents in the manner described above. In step 830, the process stages are captured using rules, as described above.

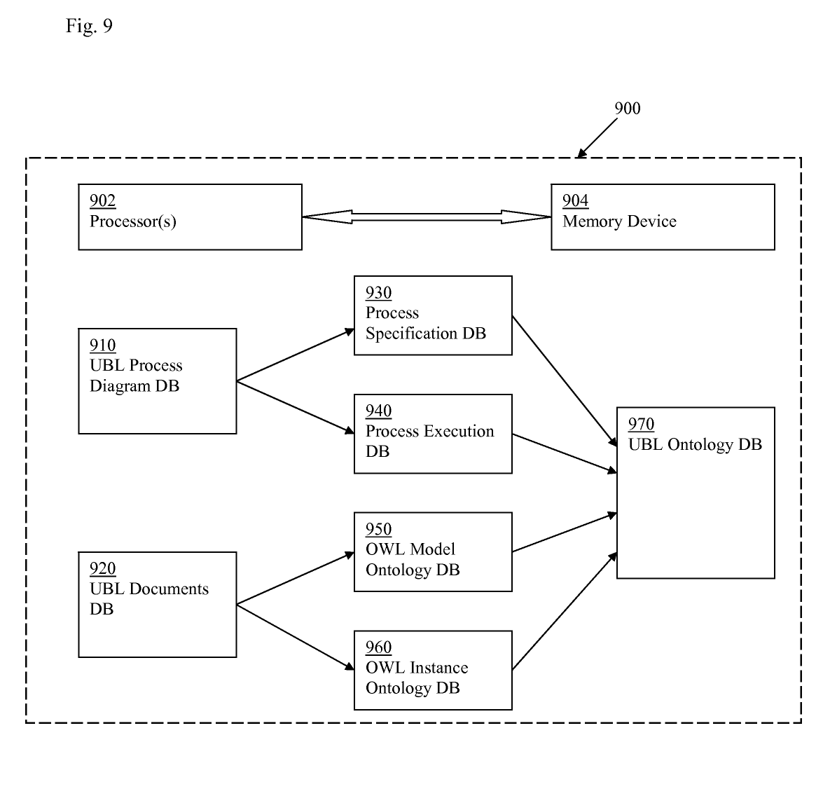

FIG. 9 illustrates a computer architecture of the disclosed embodiment. Computer system 900, which can include one or more computing devices, such as servers, PCs, handheld computing devices, and the like, includes one or more computer processors 902. The processor(s) 902 accomplish the methods disclosed above in accordance with computer readable instructions contained in tangible memory device 904. UBL process diagrams for the process are stored in database 910 and the corresponding UBL documents are stored in database 920. The process specification created from the UBL Process diagrams is stored in database 930 and the process execution information is stored in database 940. The OWL model ontology is created from the UBL documents and is stored in database 950. The OWL instance ontology is also created from the UBL documents and is stored in database 960. The resulting UBL Ontology is stored in database 970.

The disclosed embodiments create ontologies out of UBL processes, using OWL for example. This provides a common framework of a specification for the processes which allows for storing information about the process, managing process data, and query/retrieving information from the process. Other ontology languages can be used. Further, various rules can be used for instantiation based on the applicable business process.

The embodiments disclosed above may be implemented with software executed on hardware, for example, the various layers can be implemented as functional software modules executed on computing devices such as a router having a processor that executes software instructions. The layers have been segregated by function for the purpose of description. However, the hardware and software implementing the layers can be segregated or combined in any manner to achieve the desired functions. Embodiments have been disclosed herein. However, various modifications can be made without departing from the scope of the embodiments as defined by the appended claims and legal equivalents.

What is claimed:

1. A computer-implemented method for producing a workflow specification of a business process, said method comprising:
receiving a process flow model of the business process at a computing device;
receiving documents corresponding to the business process at a computing device;
generating a set of logical formulae representing the control of the process flow model using a computing device; and
applying a set of rules representing execution dependencies of activities in the business process to generate a workflow specification of the business process using a computing device.

2. The method of claim 1, wherein the flow model and the documents conform to UBL.

3. The method of claim 2, wherein the relating step comprises generating an ontology.

4. The method of claim 3, wherein the ontology conforms to OWL

5. The method of claim 1, further comprising relating activities in the business process flow model to the documents using a computing device.

6. A computer implemented method for specifying a business process using SWRL, said method comprising:
receiving BPM notations representing a business process flow using a computing device;
specifying the business process flow using OWL using a computing device;
associating semantics of the business process flow with related UBL documents in OWL using a computing device; and
applying a set of rules representing execution dependencies of activities in the business process to generate a workflow specification of the business process using a computing device using a computing device.

7. A computer readable media having computer executable instructions recorded thereon, said instructions, when executed by a processor, implementing a method for producing a workflow specification of a business process, said method comprising:
receiving a process flow model of the business process at a computing device;
receiving documents corresponding to the business process at a computing device;
generating a set of logical formulae representing the control of the process flow model using a computing device; and
applying a set of rules representing execution dependencies of activities in the business process to generate a workflow specification of the business process using a computing device.

8. The media of claim 7, wherein the method further comprises relating activities in the business process flow model to the documents using a computing device.

9. The media of claim 7, wherein the flow model and the documents conform to UBL.

10. The media of claim 9, wherein the relating step comprises generating an ontology.

11. The media of claim 10, wherein the ontology conforms to OWL.

12. A computer readable media having computer executable instructions recorded thereon, said instructions, when executed by a processor, implementing a method for specifying a business process using SWRL, said method comprising:
receiving BPM notations representing a business process flow using a computing device;
specifying the business process flow using OWL using a computing device;
associating semantics of the business process flow with related UBL documents in OWL using a computing device; and
applying a set of rules representing execution dependencies of activities in the business process to generate a workflow specification of the business process using a computing device using a computing device.
